(19) United States
(12) Patent Application Publication
(10) Pub. No.: US 2006/0294464 A1
(43) Pub. Date: Dec. 28, 2006

(54) User interface apparatus capable of providing support to user

(75) Inventors: Yoshiki Tokimoto, Nishiwaki-shi (JP); Kazuo Inui, Itami-shi (JP); Kimie Mishima, Itami-shi (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/232,951

(22) Filed: Sep. 23, 2005

(30) Foreign Application Priority Data
Jun. 23, 2005 (JP) 2005-183382

(51) Int. Cl. G06F 9/00

(52) U.S. Cl. 715/705; 715/708; 715/707; 715/727

(57) ABSTRACT

Necessity/no necessity for user support (such as enlarged display) is registered for each user or for each screen displayed on the apparatus. A user using the apparatus is specified by means of user authentication. Every time the screen is to be displayed, it is done based on information of necessity/no necessity for user support that has been registered. Thus, operability for the user can be improved.

This application is based on Japanese Patent Application No. 2005-183382 filed with the Japan Patent Office on Jun. 23, 2005, the entire content of which is hereby incorporated by reference.

### BACKGROUND OF THE INVENTION

1. Field of the Invention

The present invention relates to a user interface apparatus, and in particular, to a user interface apparatus capable of providing support for each user.

2. Description of the Related Art

Conventionally, in apparatuses such as MFP (Multi Function Peripherals) and a PC (Personal Computer), a user interface apparatus where an operation screen is displayed for a user to accept the user's input has been used.

Japanese Laid-Open Patent Publication No. 08-095688 discloses an interface apparatus where the skill of a user is inferred from the movement of fingers touching the buttons, whereby many messages are presented to an inexperienced user while message is less presented to an experienced user so that the massage presentation itself may not disturb the user.

Japanese Laid-Open Patent Publication No. 2003-316211 discloses an image formation apparatus, which is capable of providing support for a plurality of users with different disabilities optimum for each of the disabilities, and which does not impair conventional operability for users without disabilities.

U.S. Pat. No. 6,873,806 (Japanese Laid-Open Patent Publication No. 2003-337505) discloses an image formation apparatus where: contrast of an image is raised by changing the tone when an operator is the aged; an image is made recognizable by changing the color when an operator is the colorblind; texts are enlarged when an operator is the poor sighted or a person with trembling fingers; languages are changed according to an operator; and height of the touch panel is adjusted according to the height of an operator.

Among user interface apparatuses, apparatuses having a support mode for displaying an enlarged screen for those users with disabilities with their eye sights are known. Some conduct switching between the normal mode and the support mode when a switching button is pressed, and others conduct switching automatically when the user is changed.

However, a user with slightly weak eyesight may be in the following situation.

(1) Most screens (referred to as screen A) are operable without any support.

(2) On the other hand, there are some screens with small characters and less visible for the user (referred to as screen B).

In such a situation, in conventional techniques, the screen shifts to screen B according to the user's operation, and thereafter the user enlarges screen B by pressing an enlarged display key provided to the apparatus to display a screen with improved visibility (referred to as screen EB).

However, in the conventional techniques, there has been a problem that screen B that is not used by the user is displayed, and that the user's operation becomes complicated since the user must press the enlarged display key.

### SUMMARY OF THE INVENTION

The present invention has been made to solve the above-described problem, and an object thereof is to provide a user interface apparatus, a control method for a user interface apparatus, and a control program for a user interface apparatus that can improve user's operability.

In order to achieve the aforementioned object, according to one aspect of the present invention, a user interface apparatus includes: a displaying portion capable of displaying a plurality of types of screens; a determining portion determining whether or not support is necessary for a user at each of the plurality of types of screens; and an executing portion executing support in displaying on the displaying portion, in accordance with a result of the determination by the determining portion.

According to another aspect of the present invention, a control method for a user interface apparatus having a displaying portion capable of displaying a plurality of types of screens, includes: a determining step determining whether or not support is necessary for a user at each of the plurality of types of screens; and an executing step executing support in displaying on the displaying portion, in accordance with a result of the determination at the determining step.

According to still another aspect of the present invention, a control program product for a user interface apparatus having a displaying portion capable of displaying a plurality of types of screens causes a computer to execute: a determining step determining whether or not support is necessary for a user at each of the plurality of types of screens; and an executing step executing support in displaying on the displaying portion, in accordance with a result of the determination at the determining step.

According to still another aspect of the present invention, a user interface apparatus includes: a displaying portion for displaying a first screen; an instructing portion for instructing to display a next screen on the displaying portion by a user; a selecting portion for selecting one of plurality of screens, which are different types respectively, as the next screen, corresponding to the user; and a display control portion for controlling the displaying portion so that the displaying portion displays the next screen selected by the selecting portion.

According to the aspects of the invention, since necessity/no necessity of support for a user is determined at each of a plurality of types of screen and support in display is provided in accordance with the determination result, a user interface apparatus, a control method for a user interface apparatus, and a control program for a user interface apparatus that can improve operability for a user can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of an image formation system in a first embodiment of the present invention.

FIG. 2 is a block diagram showing a hardware configuration of an image formation apparatus 1 shown in FIG. 1.

FIG. 3 is a block diagram showing a hardware configuration of a client PC 6 shown in FIG. 1.

FIG. 4 shows a specific example of a screen configuration of a console 17 of the image formation apparatus.

FIG. 5 shows a specific example of screen display of a console 17 of the image formation apparatus.

FIG. 6 shows a support screen registered to the image formation apparatus.

FIG. 7 shows a table registering necessity/no necessity for support for each user.

FIG. 8 is a flow chart showing an operation of the image formation apparatus.

FIG. 9 shows the number of times of a support key being pressed as recorded by an image formation apparatus in a second embodiment.

FIG. 10 shows a specific example of a possible support range.

FIG. 11 relates to a description of a process in a third embodiment.

FIG. 12 shows a modification in the third embodiment.

### DESCRIPTION OF THE PREFERRED EMBODIMENTS

In the following, embodiments of the present invention is described.

### First Embodiment

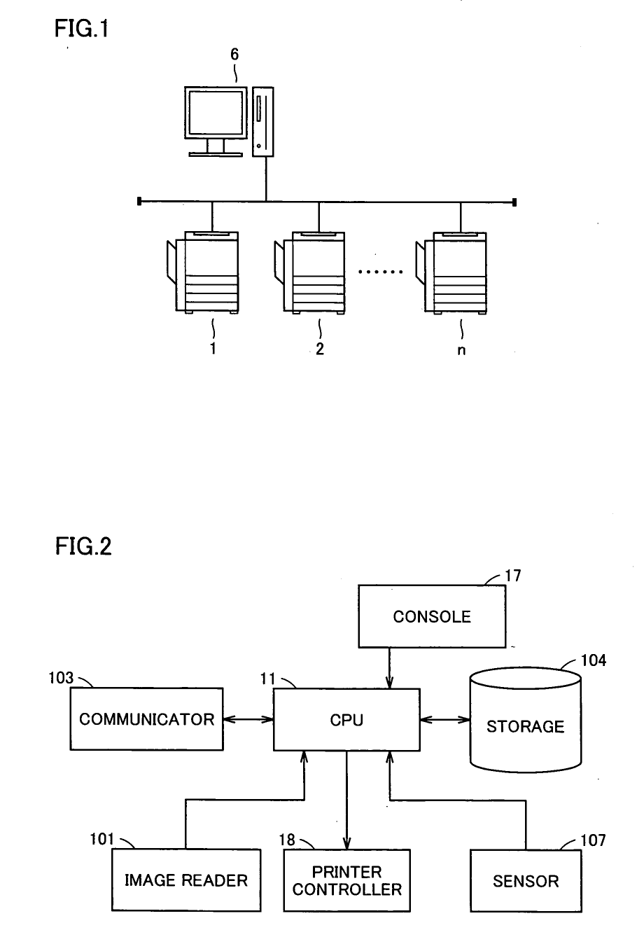

Referring to FIG. 1, an image formation system is constituted by a plurality of image formation apparatuses 1-n and a client PC 6. Image formation apparatuses 1-n and client PC 6 are connected through a network.

Image formation apparatuses 1-n form on a sheet a copy of an image of an original scanned and/or an image generated from print data transmitted from client PC 6.

FIG. 2 is a block diagram showing a hardware configuration of the FIG. 1 image formation apparatus 1. Image formation apparatuses 2-n have the same configuration as image formation apparatus 1.

Referring to the figure, the image formation apparatus includes a CPU 11 generally controlling the apparatus, an image reader 101 reading image data from an original, a printer controller 18 controlling a printer printing an image on a sheet, a communicator 103 operative to perform short-distance radio communications and connect a printing device to a line, a storage 104 storing job data, authentication data and the like, a console 17 serving as an interface with a user, and a sensor 107 for example detecting an amount of a consumable available.

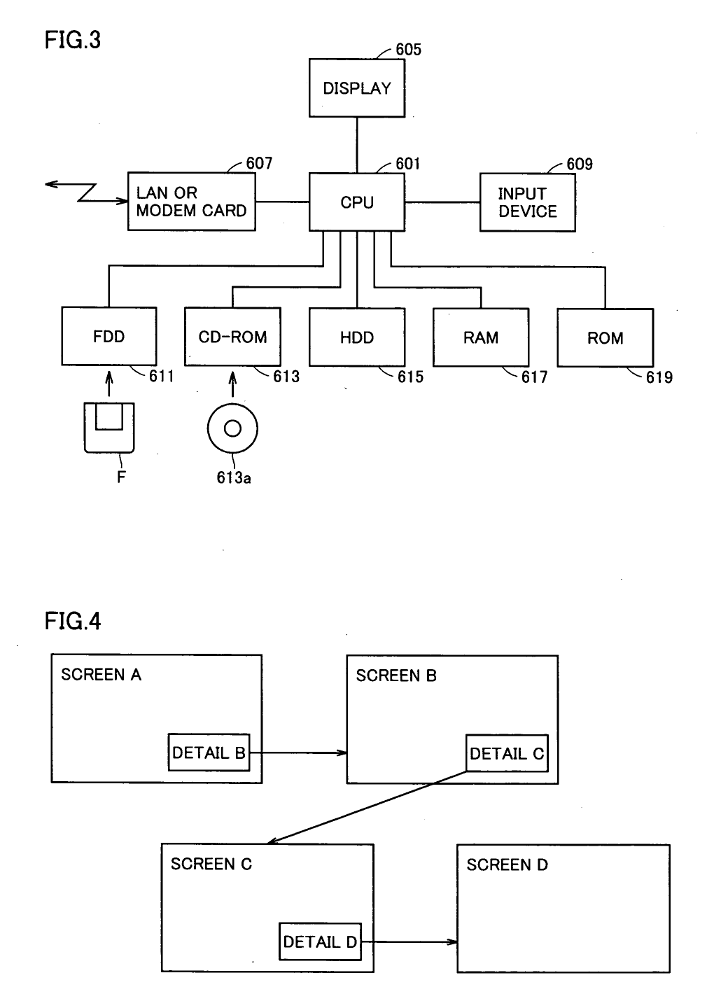

FIG. 3 is a block diagram showing a hardware configuration of a client PC 6 shown in FIG. 1.

Referring to the figure, client PC 6 includes a CPU 601 generally controlling the device, a display 605, a local area network (LAN) card 607 (or a modem card) used to connect to a network, for external communications and the like, an input device 609 configured for example of a keyboard, a mouse and the like, a flexible disk drive 611, a CD-ROM drive 613 a hard disk drive 615, a RAM 617 and a ROM 619.

Flexible disk drive 611 allows reading data such as a program and an image recorded on a flexible disk F, and CD-ROM drive 613 allows reading data such as a program and an image recorded on a CD-ROM 613a.

Console 17 of the image formation apparatus includes a display medium (here, a liquid crystal display apparatus) having support functions in operation, as well as a variety of keys (buttons). In the present embodiment, the variety of keys include, in addition to keys configured as hard keys, what is called soft keys where pressing on the liquid crystal display apparatus is detected to serve as a key. Console 17 is characterized in providing automatic switching of support such that support is not provided for the screen that a user frequently uses and that the user is familiar with, and such that support is provided only for the screen that a user infrequently uses and that the user is unfamiliar with.

Further, it has a function of automatically customizing provision of support by learning the operation habit of a user.

Generally, support means enlarged display of a screen (such as by changing the size of characters), an audio guide, display of a monochrome screen for the colorblind or the like (such as by changing the color of a screen). Providing support for the screen that a user frequently uses and is familiar with is often unnecessary. Additionally, providing support may undesirably increase procedures for setting or may impair operability.

The image formation apparatus in the present embodiment does not provide support for every screen, but provides support only for the screen that a user infrequently uses and the user is unfamiliar with.

Such a configuration achieves an effect that quick setting is possible with the screen that a user is familiar with, and that sure setting is possible with the screen that a user is unfamiliar with by appropriate support.

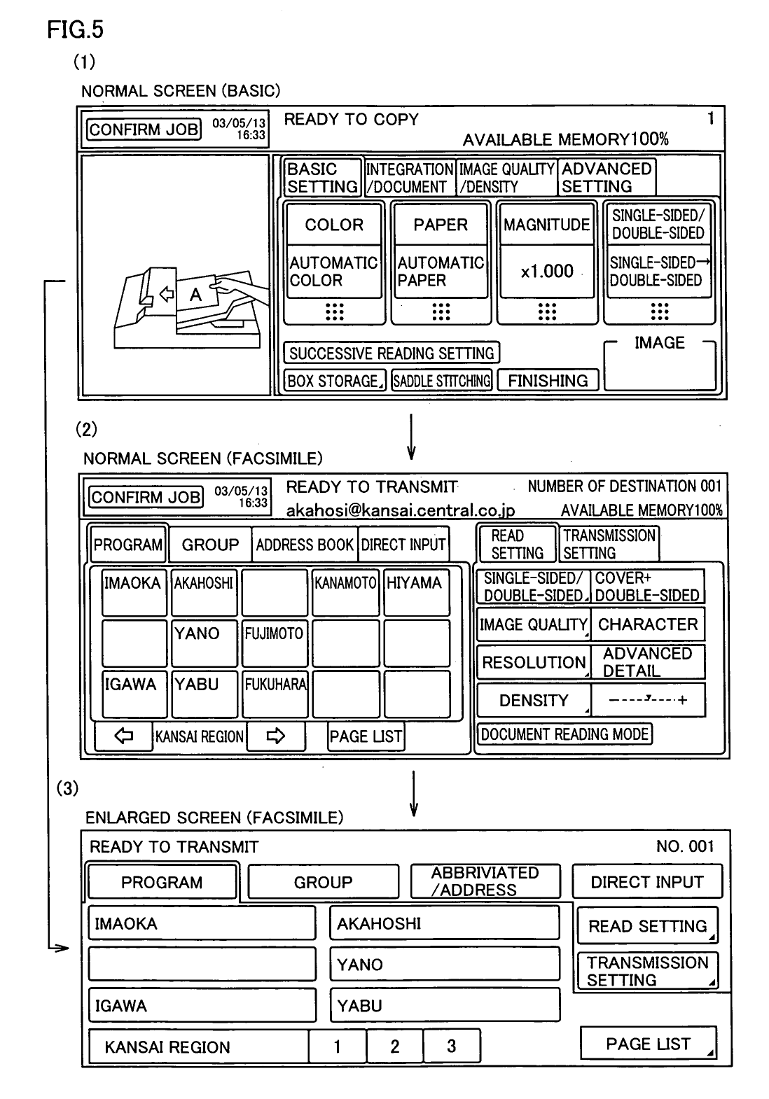

FIG. 4 shows a specific example of a screen configuration of a console 17 of the image formation apparatus.

For example, as a screen for setting functions, normally a screen (screen A) for setting the most basic functions is initially displayed. Then, often, by successively pressing detail setting keys and the like, screens (screens B→C→D) for setting more advanced functions are displayed.

As the characteristics of the screens, screen A includes a detail setting key, and when the detail setting key is pressed, a shift to screen B is conducted. Similarly, screen B also includes a detail setting key, and when it is pressed, a shift to screen C is conducted. The screens shift in this manner, wherein screen A has the most basic functions whereas screen D has the most advanced functions.

In the present embodiment, while the detail setting keys, specifically “detail B” in screen A and “detail C” in screen B function as the keys for instructing next screen display, it goes without saying that hard keys provided on the console and the like may serve as the keys for instructing the next screen, in addition to the keys included in the screens.

Not all of these four screens are always necessary. Setting of the basic functions can be completed only with screen A.

FIG. 5 shows a specific example of screen display of console 17 of the image formation apparatus.

It is assumed that there are a normal screen (basic) denoted by (1) in the figure, and a normal screen (facsimile screen) denoted by (2) in the figure. Normally, when a not-shown “facsimile transmission” key is pressed while screen (1) is displayed, screen (2) is displayed.

A description will be given as to support for the case where such screens are used by a user with slightly weak eyesight.

As screen (1) is frequently used and its screen configuration is simple, usually the user does not require support in use.

However, in screen (2) for facsimile transmission, addresses and modes are displayed altogether and it is not convenient for the user with weak eyesight to use without enlargement. Accordingly, when such a user uses the facsimile, when screen (2) has appeared, he/she presses an “enlarged display” key (not shown, it may be displayed on screen (2) as a soft key or it may be arranged out of the screen as a hard key) for switching the screen to an enlarged screen (3) so that the enlarged screen (3) is displayed on the console.

In such a procedure, screen (2) is not necessary to be displayed, since the user always switches to screen (3) without any operation with screen (2). In other words, when the user uses the facsimile, it is more efficient to display facsimile screen (3) that is initially enlarged, since unnecessary screen display can be omitted and the user is saved from having to press the enlarged display key.

Thus, for some users, it is not necessary to display screen (2) and it is more convenient to directly display screen (3) (the screen with which the user needs support).

Accordingly, in the present embodiment, with which screen support is necessary is registered for each user, and only with the screen with which support is necessary, support (such as enlarged display) is automatically provided.

Specifically, when a log-in user is determined to be the one who needs support with the facsimile transmission screen, screen (3) is directly displayed when shifting from screen (1) shown in FIG. 5 to the facsimile transmission screen, without displaying screen (2).

Thus, only when used by a specific user, by directly switching screens from (1) to (3), support can quickly be provided only for the screen with which the user needs support.

In the following, a configuration for presenting such display is described.

Here, it is assumed that there are three users who need different support in a department where an identical image formation apparatus is used.

The users are referred to as a visual-support-needed user, a β-type-support-needed user, and a γ-type-support-needed user, respectively in correspondence with the types of support.

It is also assumed that there are operation screens for setting a certain function, which are constituted by four types of screens of screens A, B, C, and D shown in FIG. 4.

One possible example of support for a visual-support-needed user may be to display a screen, which is an enlarged version of a normal screen, to be easily viewed. In other word, it is an attempt to improve visibility by enlarged display of characters and graphics. However, such an enlarged screen may be undesirable as compared to a normal screen in that the number of steps of user's operation required for setting is increased, and that the functions that can be set are limited. Accordingly, while the normal screen allows a user to conduct setting quickly, providing support may suppress such quickness, although it allows a user who needs support to conduct appropriate setting.

Support may include, in addition to the enlarged screen, an audio guide mode or a colorblind mode may be provided; the position of the touch panel may be mechanically adjusted for the users on wheelchair or for children; or the display in Braille may be provided, as universal designs. In other words, a plurality of support methods such as of visual, audio, and touch sense as universal designs are executed in the display medium.

The image formation apparatus switches such different types of support for each user, and provides support only when the user needs. The user can customize such support.

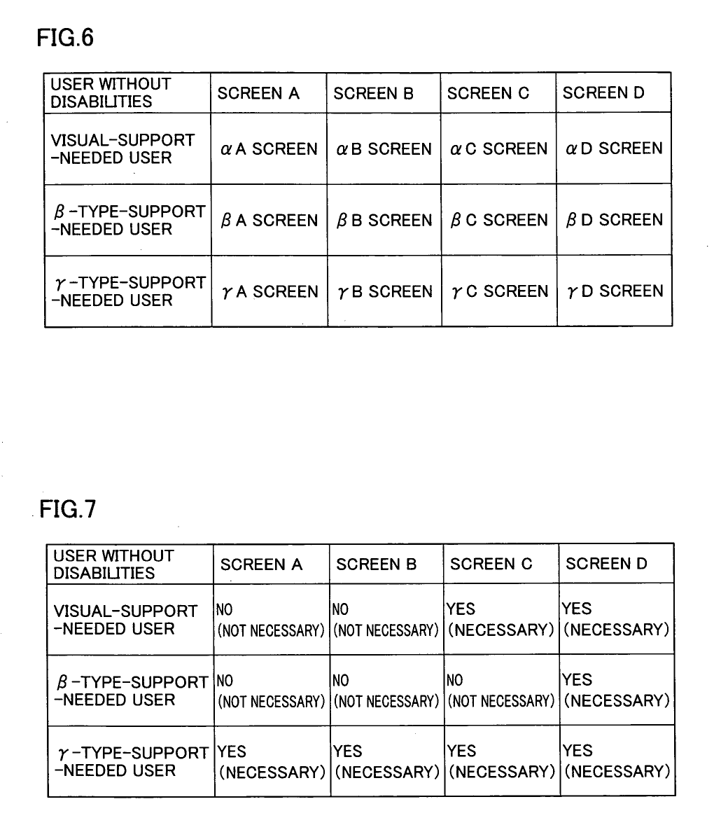

FIG. 6 shows a support screen registered to the image formation apparatus.

In order to provide a plurality of types of support in correspondence with the normal screens A-D, support screens αA, αB, αC, and αD are prepared for a visual-support-needed user respectively for screens A-D. Similarly, support screens βA, βB, βC, and βD are prepared for a β-type-support-needed user. Support screens γA, γB, γC, and γD are prepared for a γ-type-support-needed user.

FIG. 7 shows a table registering necessity/no necessity for support for each user.

A manager of the apparatus registers necessity/no necessity for support as to each screen A-D based on desires of each user, characteristics of screens and the like. It is also possible to perform the registration to a server so that the same display is attained in devices such as a plurality of image formation apparatuses.

Referring to FIG. 7, for example for a visual-support-needed user, support is not necessary for screens A and B since they are frequently used, while support screens αC, and αD are needed for screens C and D, since screens C and D are infrequently used advanced function screens.

In the steps where screen shifts from A to D, no support is provided for a visual-support-needed user with screens A and B that are frequently used. Thus, quick setting can be achieved without using enlarged screens αA and αB that require a procedure for setting.

Additionally, according to conventional techniques, the enlarged display key is pressed only when screen C is entered in order to switch to screen αC. In contrast, according to the present embodiment, screen αC is directly displayed based on the registered information of the manager, without displaying screen C. By starting support from C screen, an effect that quick setting is possible for the basic functions, and that sure setting is possible for the advanced functions can be attained.

In the table shown in FIG. 7, as to the screens for a β-type-support-needed user, support with screens A-C is not provided and support is only provided with screen D. As to the screens for a γ-type-support-needed user, support is provided with all screens A-D.

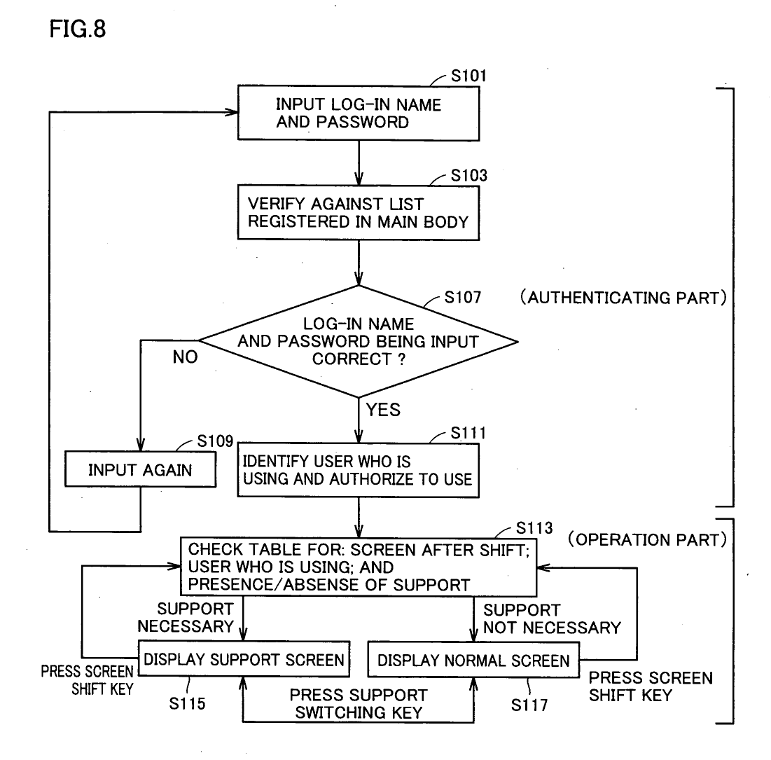

FIG. 8 is a flow chart showing an operation of the image formation apparatus in the present embodiment.

Referring to the figure, the flow consists of an authentication process portion and an operation portion.

In a waiting state at step S101, a screen requesting a log-in name and a password is always displayed, and the user desires to use the apparatus inputs them. Thus, use of the apparatus can be prohibited to outsiders, and the user using the apparatus can be identified.

At step S103, whether the input log-in name and password are registered on a list that has been registered in advance is verified. At step S107, if the input log-in name and password are not authentic, the user is prompted to input again at step S109. Then the process goes back to step S101.

If the input log-in name and password are authentic, then the user using the apparatus is identified at step S111, and a usage authorized state is entered.

At step S113, by verifying the screen to be displayed, the user using the apparatus, and the table in FIG. 7 against one another, whether or not support for screen display is necessary is determined.

If support is necessary, then the support screen is displayed at step S115. If support is not necessary, then a normal screen is displayed at step S117. When a key for shifting the screen is pressed, the process goes back to step S113.

The display between steps S115 and S117 is switched for each time a support switching key included in console 17 is pressed. This improves convenience for the user.

Although the present invention has been described in the above embodiment showing the example of screen display of the image formation apparatus, it is also possible to apply the present invention to a car navigation apparatus, as a specific application.

In a car navigation apparatus, sometimes an audio guide function may be used. However, on a familiar road, often the audio guide is unnecessary. It is expected that there is a desire for the audio guide to be started at an unfamiliar road.

In such a case, the apparatus may be set such that no audio guide is provided (no support is provided) in a city, and such that the audio guide is provided when the driver is on the highway. Thus, automatic switching is achieved so that the driver can normally focus on driving without being disturbed by unnecessary audio, and that the guide is provided only when traveling to far places.

### Second Embodiment

A configuration of an image formation system in a second embodiment is the same as that in the first embodiment. Therefore, description thereof is not repeated.

The second embodiment is characterized in employing a scheme in which whether or not to provide user support is automatically switched.

Specifically, assuming displaying of screens A-D shown in FIG. 4, counters respectively corresponding to screens A-D are prepared for each user to be supported. For each screen, the number of times that a normal screen is switched to a support screen is counted and stored.

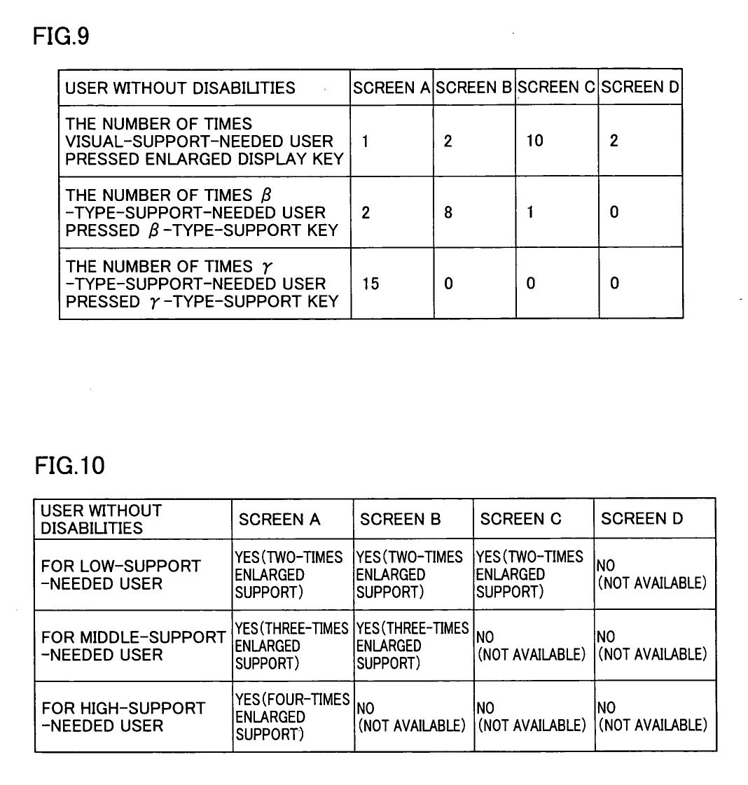

FIG. 9 shows the number of times of a support key being pressed as recorded by an image formation apparatus in the second embodiment.

In the case represented by FIG. 9, as the enlarged display key (one of support keys) is infrequently pressed with screens A and B, and thus it can be considered that support is not necessary. As it is frequently pressed on screen C, it can be considered that support is necessary for screen C and the following screens.

Assume that, as a determination reference for performing automatic support switching, support is set to be automatically provided after the key operation is performed for ten times. Then, when the user enters screen C by screen shift, support screen αC is automatically displayed.

The number of times of key operation in response to which support is provided (count reference) may be changeable from the console.

By providing such a learning function, in addition to the function in the first embodiment, the following advantages can be obtained.

(1) The burden of the manager in support definition operations can be alleviated.

(2) Although necessity/no necessity for support is not known until the apparatus is actually used and it is a trouble to register necessity/no necessity for support, the present embodiment realizes customizing as desired by a user based on the usage state.

Although in the present embodiment it has been shown that the number of a support key being pressed is counted and the count is determined so that the apparatus learns the user's habit, the following additional determination methods may be possible:

Store the previous necessity/no necessity for support, and provide support in accordance with the storage; and

Check the interval of pressing the key, and provide support accordingly.

Although the present invention has been described in the above embodiment showing the example of screen display of the image formation apparatus, it is also possible to apply the present invention to a browser of a personal computer, as a specific application.

When opening a Web page with a browser, a page containing image and/or video is large in data volume and therefore takes time to be opened. Assume that a user needs only text information and does not need image and/or video, and performs operation for not obtaining image information or the like. Then, when the user opens the page thereafter, the browser operates giving higher priority in obtaining text information while not obtaining images automatically.

Further, it is also possible to configure the apparatus to store the type of information to be obtained so that page display is performed based thereon when opening the same Web page as the previous one.

### Third Embodiment

A configuration of an image formation system in a third embodiment is the same as that in the first embodiment. Therefore, description thereof is not repeated.

In the third embodiment, when a screen to be displayed is not the target of support, similar support is provided.

The above-described embodiments are on the premise that the support screens are prepared for all the screens A-D. However, with a large number of screens to be displayed, it may not be possible to provide support for all of the screens.

FIG. 10 shows a specific example of a possible support range.

A simple example may be assumed as to enlarged display, where stepwise enlarged display is prepared, such as two-times, three-times, four-times enlargement. Here, two-times enlargement is for a low-support needed user, three-times enlargement is for a middle-support needed user, and four-times enlargement is for a high-support needed user. In this case, screen A is simple, and therefore it is possible to provide support up to four-times enlargement. Screen B has a complicated configuration as compared to screen A, and therefore it is not capable of providing support of four-times enlargement, and it is only capable of providing support up to three-times enlargement.

With screen C, it is capable of providing support up to two-times enlargement, and screen D has no enlargement support.

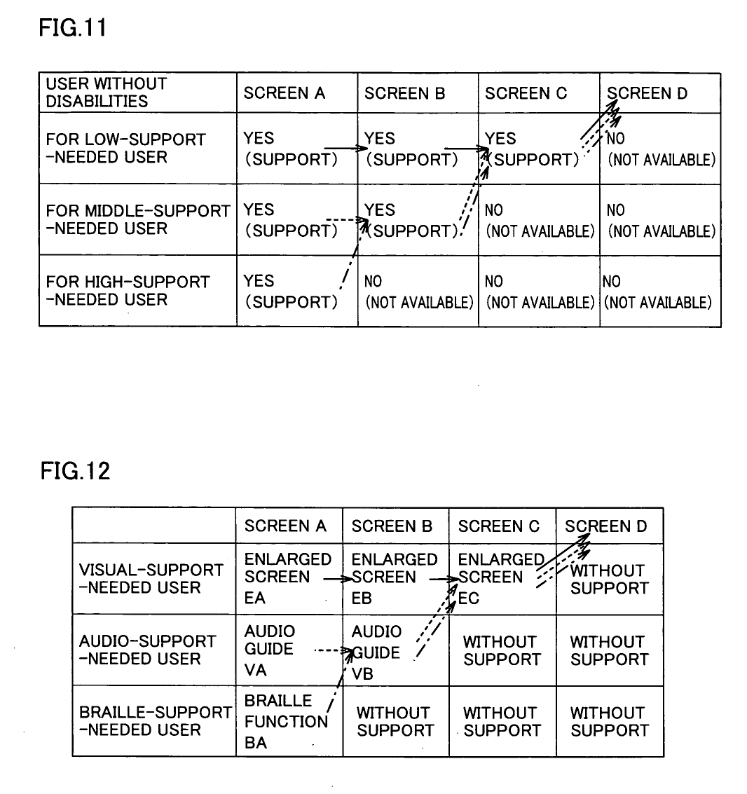

FIG. 11 relates to a description of a process in the third embodiment.

Assume that a high-support needed user has conducted operation and screen A shifts to screen B. With screen B, support of four-times enlargement is not provided, and therefore four-times enlarged display is not available. Here, when the screen shifts to screen B, a massage “Four-times enlarged display is not possible. Three-times enlarged display will be provided” is displayed (or output as voice), and three-times enlarged display is provided when the screen has shifted to screen B. While it is a slightly inconvenient screen for the high-support needed user, he/she may be capable of using it as it is three-times enlarged display. If the screen returns to screen A, four-times enlarged display is again provided.

As above, when support is not available, in place of immediately stopping support (displaying screen B without support), it is automatically switched to provide the next similar type of support. Thus, the possibility for the user to use the apparatus can be increased.

FIG. 12 shows a modification in the third embodiment.

In the above embodiment, while description has been given with the enlargement times of the screens, usage as represented by FIG. 12 is also possible. Assume that when a Braille-support needed user (or a colorblind) is using the apparatus, a screen shifts to a screen with which Braille support is not provided (screens A→B). Assume that audio guide support is provided with that screen. In this case, shift is made to the screen with which audio guide support is provided. Such an operation possibly allows the user to operate the apparatus by the audio guide, who is not capable of operating the apparatus with a normal screen.

Although the present invention has been described in the above embodiment showing the example of screen display of the image formation apparatus, it is also possible to apply the present invention to a car navigation apparatus, as a specific application.

In the car navigation apparatus, it is assumed that audio guide support and enlargement display support are provided. The audio guide provides support for major roads, while it may not be capable of providing support in a heavily built-up area such as a residential area. Here, such usage is possible that, when the car enters an area where the audio guide support is not provided, support is continuously provided by automatically switching to enlarged display (the next support function).

As above, according to the embodiment of the present invention, such an effect is attained that the manner of screen shift or the way of support can be customized for each screen in accordance with the user of the apparatus.

It is noted that the present invention is not limited to an image formation apparatus, a PC, a car navigation apparatus or the like, and it may be applied to the devices such as a mobile terminal, a mobile phone, household appliances or the like so long as it is a user interface apparatus where display is conducted by means of screens, voices or the like.

In the above-described embodiment, a user who operates the image formation apparatus first undergoes user authentication. For example, by inputting an ID and a password from a console, user authentication is performed from an authenticating portion inside or outside the image formation apparatus (in the latter case, an authenticating apparatus connected through a network or the like). The user authorized by this user authentication can be identified as the user who is operating the apparatus.

In the above-described embodiment, while description has mainly been given to the console of the image formation apparatus, the operation of the image formation apparatus can be performed from a client PC connected through a network. To a user interface apparatus constituted by display 605 and input apparatus 609 in such a client PC, the above-described embodiment can also be applied.

The processes in the above-described embodiment can be performed by software or hardware circuitry.

It is also possible to provide a program executing processes in the above-described embodiment. The program may be recorded on a recording medium such as a CD-ROM, a flexible disk, a hard disk, a ROM, a RAM, a memory card and the like to be provided to a user. The program may be downloaded into the apparatus through a communication line such as the Internet.

The present invention is applicable to a system connected to a network, or to a system not connected to a network environment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A user interface apparatus, comprising:
a displaying portion capable of displaying a plurality of types of screens;
a determining portion determining whether or not support is necessary for a user at each of said plurality of types of screens; and
an executing portion executing support in displaying on said displaying portion, in accordance with a result of the determination by said determining portion.

2. The user interface apparatus according to claim 1, further comprising
an identifying portion identifying a user using the apparatus, wherein
said determining portion determines whether or not support is necessary at each of said plurality of types of screens for said specified user.

3. The user interface apparatus according to claim 2, wherein
said executing portion is capable of executing a plurality of types of support for one screen, and
said determining portion includes a storage portion storing user information for each of a plurality of users, and determines which type of support is to be executed for a screen by using the user information in said storage portion.

4. The user interface apparatus according to claim 3, further comprising
a registering portion registering the user information in said storage portion.

5. The user interface apparatus according to claim 1, further comprising
a switching portion switching between whether or not support is executed by said executing portion, in accordance with a user's input.

6. The user interface apparatus according to claim 5, wherein
said determining portion determines whether or not support is necessary for a user, based on a state of switching by said switching portion.

7. The user interface apparatus according to claim 6, wherein
said determining portion includes a counter counting for each screen times of switching by said switching portion, and determines whether or not support is necessary for a user based on the count.

8. The user interface apparatus according to claim 7, further comprising
a changing portion changing a count reference for determining whether or not support is necessary for a user.

9. The user interface apparatus according to claim 1, wherein
in a situation where said executing portion is incapable of executing a certain type of support, said execution portion executes another type of support.

10. The user interface apparatus according to claim 9, wherein
said situation where said executing portion is incapable of executing a certain type of support is a situation where a screen with a support function used by the user shifts to a screen without support, and upon such a situation, said executing portion informs the user of the shift to the screen without support, and executes alternative support according to the user.

11. The user interface apparatus according to claim 1, wherein
said execution of support is at least one of: display of a screen being different in size of characters; display of a screen being different in colors to be displayed; and provision of an audio guide.

12. A control method for a user interface apparatus having a displaying portion capable of displaying a plurality of types of screens, comprising:
a determining step determining whether or not support is necessary for a user at each of said plurality of types of screens; and
an executing step executing support in displaying on said displaying portion, in accordance with a result of the determination at said determining step.

13. A control program product for a user interface apparatus having a displaying portion capable of displaying a plurality of types of screens, causing a computer to execute:
a determining step determining whether or not support is necessary for a user at each of said plurality of types of screens; and
an executing step executing support in displaying on said displaying portion, in accordance with a result of the determination at said determining step.

14. A user interface apparatus, comprising:
a displaying portion for displaying a first screen;
an instructing portion for instructing to display a next screen on the displaying portion by a user;
a selecting portion for selecting one of plurality of screens, which are different types respectively, as the next screen, corresponding to the user; and
a display control portion for controlling the displaying portion so that the displaying portion displays the next screen selected by the selecting portion.

15. The user interface apparatus according to claim 14, wherein the plurality of screens are similar but nonidentical in their respective contents to be displayed.

16. The user interface apparatus according to claim 14, wherein the plurality of screens are different in size of characters to be displayed at respective screens.

17. The user interface apparatus according to claim 14, wherein the plurality of screens are different in color to be displayed at respective screens.

18. The user interface apparatus according to claim 14, further comprising
a changing portion for changing the next screen to another screen which is one of the plurality of screens.

19. The user interface apparatus according to claim 18, further comprising
a counter for counting times of changing by the changing portion, wherein based on the count of the counter, the selecting portion selects one of the plurality of screens as the next screen.

20. The user interface apparatus according to claim 14, wherein specifying of the user is performed by a user authentication that is conducted prior to the instruction by the instructing portion.

21. A control method for a user interface apparatus, comprising the following steps of:
displaying a first screen on a displaying portion;
accepting an instruction for displaying a next screen on the displaying portion by a user;
selecting one of plurality of screens, which are different types respectively, as the next screen, corresponding to the user; and
displaying the next screen on the displaying portion.

22. A control program product for a user interface apparatus, causing a computer to execute:
displaying a first screen on a displaying portion;
accepting an instruction for displaying a next screen on the displaying portion by a user;
selecting one of plurality of screens, which are different types respectively, as the next screen, corresponding to the user; and
displaying the next screen on the displaying portion.
